(19) United States
(12) Patent Application Publication
(10) Pub. No.: US 2002/0075533 A1
(43) Pub. Date: Jun. 20, 2002

(54) Method and device to fabricate holographic gratings with large area uniformity

(75) Inventors: Byung Kwon Kang, Suwon-City (KR); Seok Lee, Seoul (KR); Yoon Ho Park, Ijungbu-City (KR); Deok Ha Woo, Seoul (KR); Sun Ho Kim, Koyang-City (KR); Jeong Su Yang, Seoul (KR); Jong Han Song, Seoul (KR)

Correspondence Address: GREENBLUM & BERNSTEIN, P.L.C., 1941 ROLAND CLARKE PLACE, RESTON, VA, 20191, US

(73) Assignee: KOREA INSTITUE OF SCIENCE AND TECHNOLOGY, Seoul (KR)

(21) Appl. No.: 09/942,675

(22) Filed: Aug. 31, 2001

(30) Foreign Application Priority Data
Dec. 19, 2000 (KR) 78,678

(51) Int. Cl. G03H 1/02

(52) U.S. Cl. 359/35; 359/27

(57) ABSTRACT

In order to have a wanted exposure pattern, a specific intensity of light should be irradiated for a certain time interval since the exposing degree of the photoresist depends on the intensity of the incident light. The intensity of the light emitted from a light source such as a conventional laser has the Gaussian distribution in space, and the Gaussian distribution is maintained after passing a conventional lens. And the uniform area is limited to a very narrow area since the exposure pattern is changed with the intensity distribution of the light incident to the photoresist.

### BACKGROUND OF THE INVENTION

1. Field of the Invention

This invention relates to the method and device to fabricate holographic diffraction gratings with large area uniformity. In particular, according to the present invention, the Gaussian distribution intensity of the light source is flattened and the uniform intensity area is increased to the size of the effective area where the appropriate intensity is maintained. And a holographic diffraction grating with large area, less than the effective area of the lens, could be manufactured despite relatively small radius optical devices.

2. Description of the Related Art

Due to the sudden increase in the capacity of the information telecommunications there has been great development in the field of optical communications, and wavelength division method was developed to keep pace with this increase in capacity. In the wavelength division method, specific narrow wavelengths are aligned with a uniform interval in order to use the wide passing band of the optical fiber, and the data signals are assigned to the each narrow wavelength to transmit.

The most important factor of the above technology is to maintain uniformity in the wavelengths. The distributed feedback (DFB) laser maintains the uniformity of the wavelength of the optical source. The light of a specific wavelength can be transmitted/reflected at the optical fiber grating in the optical fiber path. The production of the grating is the key factor in these types of optical elements.

A uniform diffraction grating reflecting a specific wavelength should be formed in the internal structure of the semiconductor DFB laser, and the case of the optical fiber grating is the same. The above mentioned production technology of the diffraction grating is as follows. An interference pattern of a uniform interval is produced through the angular difference of two lights of different paths, which are initially of the same wavelength but are incident to a specific surface at different angles. When a photoresist, which reacts only to a specific wavelength, is applied to the surface, the interference pattern is transcribed. Based on this interference pattern on the photoresist the surface of the semiconductor can be engraved to obtain a grating pattern of uniform spacing.

In the case of the optical fiber, this interference pattern is formed on the optical fiber, which has the ability to change refraction rates in accordance to the intensity of the light of a specific wavelength. And an optical fiber grating can be obtained from the parts with different refraction rates.

The schematic of the traditional device, which produced these interference patterns, is illustrated on FIG. 1. FIG. 1 is the schematic that shows the traditional method of producing a holographic interference grating. The traditional grating production device is composed of an ultraviolet laser (10) emitting an ultraviolet (UV) light of a single wavelength, an object lens (12) focusing the UV light on the pin hole, a pin hole (14) filtering the noise component of the laser beam, a collimating lens (16) making the magnified light parallel to the sample (18) in a parallel direction, and a mirror (20), attached on the opposite side of the sample (18), to control the angle between the incident light and the reflected light.

The light emitted by the single wavelength UV laser, is focused on the pin hole (14) by the objective lens (12), and it is transmitted through the spatial filter to remove the noise component. The collimating lens (16) is then utilized to make the magnified beam parallel to the sample (18). The sample (18) is placed in the beam path so that the reflected light has a specific angle with the incident light at the sample (18) with the mirror (20) located on the opposite side of the sample (18), and the spacing of the interference pattern is controlled.

However, in a schematic like FIG. 1, the light transmitted through the collimating lens (16) retains a Gaussian distribution, and the light transmitted through the middle of the lens has a higher intensity than light transmitted through the edge of the lens as shown in FIG. 2. In the case of the photoresist or the optical fiber of variable refraction, a distribution over a wide area of the constant intensity part is required because the refraction rate or the level of the light reduction depends on the intensity of the light. Yet, in traditional devices as shown in FIG. 1, the acquisition of a part of uniform intensity was very difficult and in general a narrow area with a small difference in intensity was used.

The size of the sample had to be decreased due to the fact that an area of relatively uniform intensity could only be realized in a relatively small area in comparison to the size of the magnified beam. Thus, it is the problem that relatively large optics should be used in order to handle larger samples.

### SUMMARY OF THE INVENTION

The present invention is contrived in order to solve the above problem. It is an object of the present invention to provide the method and device to fabricate holographic gratings with large area uniformity while using an optical system of a small radius. According to the present invention, the Gaussian distribution intensity of the light source is flattened and the uniform intensity area is increased to the size of the effective area where the appropriate intensity is maintained. Therefore, a diffraction grating with large area, less than the effective area of the lens, could be manufactured despite relatively small radius optical devices.

Another aim of the present invention is to produce an economical method and device to fabricate holographic gratings with large area uniformity while using an optical system of a small radius. The present invention is very cost-effective compared to the traditional method where the optical devices such as the objective lens and the mirror of large radius should be used to get a diffraction grating with large area. In the process of the development and the engraving after the exposure, since the overall light intensity is uniform, the measurement and the evaluation for the present sample are simpler than those for the samples made with the traditional methods.

The intensity distribution of the light source should be changed from a Gaussian distribution to a uniform distribution to obtain the above goals. This can be achieved through flattening the intensity distribution of the light source by transmitting the light through an inverse-Gaussian transmission filter, which has been standardized to a specific point in the Gaussian distribution.

### BRIEF DESCRIPTION OF THE DRAWINGS

Exemplary embodiments of the present invention will be described in conjunction with the drawings in which:

FIG. 1 illustrates the manufacturing process of the traditional holographic grating;

FIG. 2 shows the distribution of the general Gaussian beam;

FIG. 3 illustrates the theory of flattening the Gaussian beam in accordance with the present invention;

FIG. 4 shows an example of the transmission type holographic grating manufacturing process in accordance with the present invention; and

FIG. 5 illustrates a different example of the production process of a reflection type holographic grating.

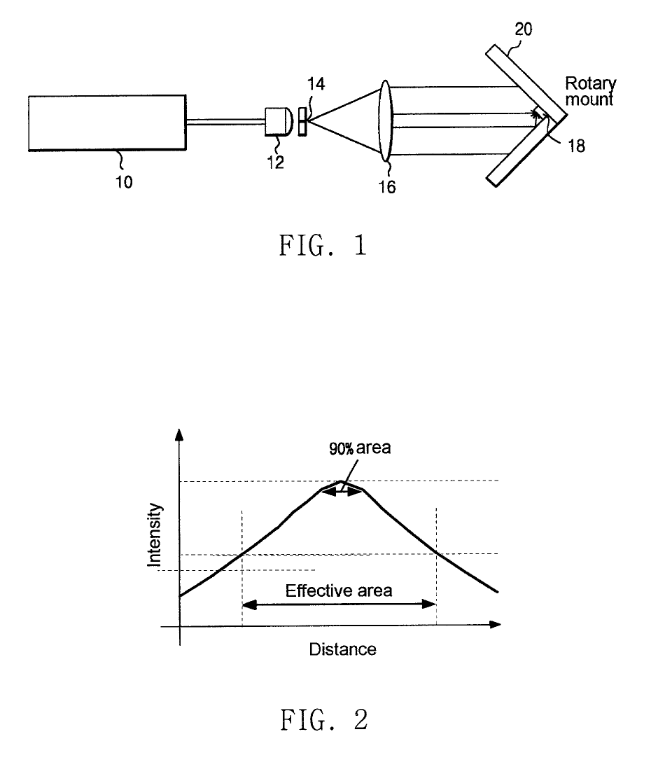

### <EXPLANATIONS FOR MAIN SYMBOLS IN THE DRAWINGS>

10: UV laser

12: Objective lens

14: Pin hole

16: Collimating lens

18: Sample

20: Mirror

22: Inverse-Gaussian transmission filter

24: Inverse-Gaussian reflection mirror

### DETAILED DESCRIPTION OF THE EMBODIMENTS

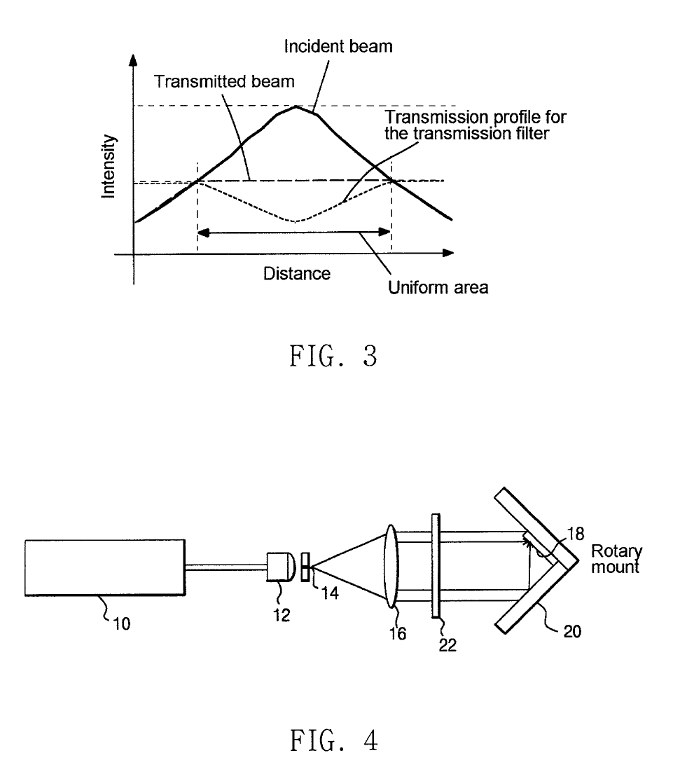

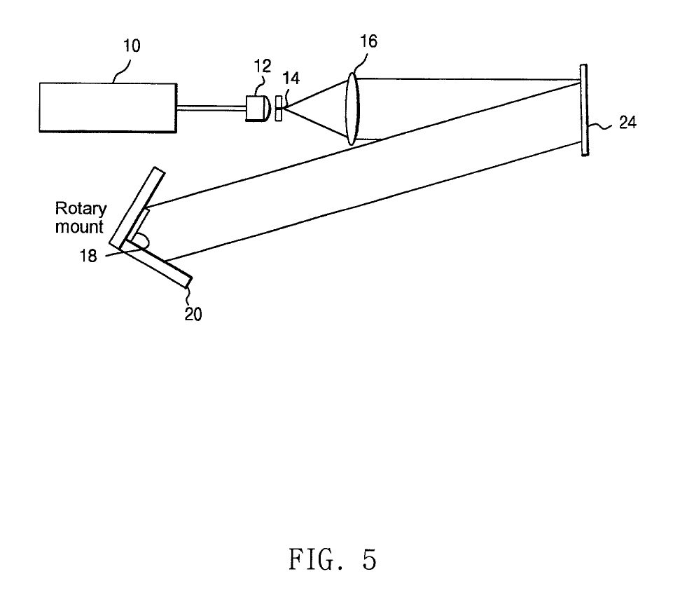

The explanation of the present invention with reference to FIGS. 2 and 5 is as follows. The method of maintaining the uniform intensity from the light of a Gaussian distribution by transmitting the light through an inverse-Gaussian filter is as follows. FIG. 2 illustrates a distribution of a general Gaussian beam. When the areas, which can be used as a relatively uniform area, are defined as the 90% area of the peak intensity, only a small area can be selected as shown on FIG. 2. But the grating can be formed over a relatively larger area if the 50% intensity area could all be utilized.

FIG. 3 shows the method to produce a uniform intensity at approximately 50% peak intensity from a Gaussian beam. When selecting the area of peak intensity 50%, the beam is transmitted through an inverse-Gaussian neutral density (ND) filter, as an inverse-Gaussian passing filter (22). This filter has the transmission rate of the center is set at 50% while the transmission rate increases to 100% towards the edge where the intensity of the incident beam is at 50%. Thus, the light intensity over the entire area of the inverse-Gaussian transmission filter (22) becomes uniform, and a uniform interference pattern over the entire area of the sample (18) is produced.

In the case of the inverse-Gaussian transmission filter (22), maintaining a uniform filter thickness is difficult. This problem can be avoided by using a reflection mirror. For this case, the reflection rate of the center of the inverse-Gaussian reflective mirror (24) is set at 50% while increasing the reflection rate toward the edge so that 100% reflection occurs when the incident beam intensity is at 50% of the peak intensity.

In other words, when selecting the standard area of the peak intensity, the transmission/reflection rate of the center should be selected as the standard %. And the transmission/reflection rate should be increased towards the edge so that the inverse-Gaussian transmission filter (22) or the inverse-Gaussian reflection mirror (24) transmits/reflects 100% when the intensity of the incident beam is at the standard %. Accordingly, the light intensity of a Gaussian distribution is flattened so that the uniform intensity area is increased to an effective area where the intensity maintains an appropriate level.

FIG. 4 illustrates the schematic when an inverse-Gaussian transmission filter (22) is used. As shown in FIG. 4, the light emitted by the single wavelength UV laser (10), is focused on the pin hole (14) by the objective lens (12), and it is transmitted through the spatial filter to remove the noise component. The collimating lens (16) is then utilized to make the magnified beam passing through the inverse-Gaussian transmission filter (22) and parallel to the sample (18). The sample (18) is placed in the beam path so that the reflected light has a specific angle with the incident light at the sample (18) with the mirror (20) located on the opposite side of the sample (18), and the spacing of the interference pattern is controlled.

When the intensity of the uniform area is selected to be 50% of the peak intensity of the magnified beam, the beam is transmitted through an inverse-Gaussian transmission filter (22). This filter has the transmission rate of the center which is set at 50% while the transmission rate increases to 100% towards the edge where the intensity of the incident beam is at 50%. Thus, the light intensity over the entire area of the inverse-Gaussian transmission filter (22) becomes uniform, and a uniform interference pattern over the entire area of the sample (18) is produced.

FIG. 5 illustrates another schematic when an inverse-Gaussian reflection mirror (24) is used. As shown in FIG. 5, the light emitted by the single wavelength UV laser (10), is focused on the pin hole (14) by the objective lens (12), and it is transmitted through the spatial filter to remove the noise component. The collimating lens (16) is then utilized to make the magnified beam reflecting by the inverse-Gaussian reflection mirror (24) and parallel to the sample (18). The sample (18) is placed in the beam path so that the reflected light has a specific angle with the incident light at the sample (18) with the mirror (20) located on the opposite side of the sample (18), and the spacing of the interference pattern is controlled.

When the intensity of the uniform area is selected to be 50% of the peak intensity of the magnified beam, the beam is reflected by an inverse-Gaussian reflection mirror (24). This mirror has the reflection rate of the center is set at 50% while the reflection rate increases to 100% towards the edge where the intensity of the incident beam is at 50%. Thus, the light intensity over the entire area of the inverse-Gaussian reflection mirror (24) becomes uniform, and a uniform interference pattern over the entire area of the sample (18) is produced. In FIG. 5, the incident and reflection angles should be minimized so that the reflection from the inverse-Gaussian reflection mirror (24) is uniform. In a device built in accordance with the present invention, the inverse-Gaussian transmission filter (22) and the inverse-Gaussian reflection mirror (24) should retain an optical plane so that interference has no effect.

As mentioned above, according to the present invention, the Gaussian distribution intensity of the light source is flattened and the uniform intensity area is increased to the size of the effective area where the appropriate intensity is maintained. Therefore, a diffraction grating with large area, less than the effective area of the lens, could be manufactured despite relatively small radius optical devices. And it is very cost-effective compared to the traditional method where the optical devices such as the objective lens and the mirror of large radius should be used to get a diffraction grating with large area. In addition, in the process of the development and the engraving after the exposure, since the overall light intensity is uniform, the measurement and the evaluation for the present sample are simpler than those for the samples made with the traditional methods.

While the foregoing invention has been described in terms of the embodiments discussed above, numerous variations are possible. Accordingly, modifications and changes such as those suggested above, but not limited thereto, are considered to be within the scope of the following claims.

What is claimed is:

1. A method to fabricate holographic gratings with large area uniformity wherein the Gaussian distribution intensity of the light source is flattened, the uniform intensity area is increased to the size of the effective area where the appropriate intensity is maintained, and then the beam is incident to the sample.

2. A method to fabricate holographic gratings with large area uniformity as defined in claim 1 wherein transmission material or reflection material is used, where, when selecting the standard area of the peak intensity as the flat level of the incident beam, the transmission/reflection rate of the center should be selected as the standard %, and the transmission/reflection rate should be increased towards the edge to 100% when the intensity of the incident beam is at the standard %.

3. A method to fabricate holographic gratings with large area uniformity as defined in claim 1 wherein an inverse-Gaussian transmission filter flattens the Gaussian beam.

4. A method to fabricate holographic gratings with large area uniformity as defined in claim 1 wherein an inverse-Gaussian reflection mirror flattens the Gaussian beam.

5. A method to fabricate holographic gratings with large area uniformity as defined in claim 3 or claim 4 wherein the inverse-Gaussian transmission filter or the inverse-Gaussian reflection mirror maintains the optical plane.

6. A device to fabricate holographic gratings with large area uniformity comprising
(1) an UV laser emitting an ultraviolet (UV) light of a single wavelength;
(2) an objective lens focusing the UV light on a pin hole;
(3) a pin hole filtering the noise component of the laser beam;
(4) a collimating lens making the magnified light parallel to the sample in a parallel direction; and
(5) a mirror, attached on the opposite side of the sample, to control the angle between the incident light and the reflected light, and wherein
(6) an inverse-Gaussian transmission filter or an inverse-Gaussian reflection mirror is located between the collimating lens and the sample.

7. A device to fabricate holographic gratings with large area uniformity defined in claim 6 wherein the inverse-Gaussian transmission filter is a neutral
